(19) United States
(12) Patent Application Publication
(10) Pub. No.: US 2026/0315920 A1
(43) Pub. Date: Oct. 15, 2026

(54) SELECTION OF USER INTERFACE ELEMENTS USING DIRECTIONAL INPUT

(71) Applicant: Roblox Corporation, San Mateo, CA (US)

(72) Inventors: Sasha KUHNE, San Mateo, CA (US); Jasmine ZHANG, San Mateo, CA (US); Jan MÜLLER, San Mateo, CA (US); Mike MARIANO, San Mateo, CA (US)

(73) Assignee: Roblox Corporation, San Mateo, CA (US)

(21) Appl. No.: 19/465,345

(22) Filed: Jan. 30, 2026

Related U.S. Application Data
(60) Provisional application No. 63/752,551, filed on Jan. 31, 2025.

(51) Int. Cl. A63F 13/426; A63F 13/24; G06F 3/04842

(52) U.S. Cl. CPC A63F 13/426; A63F 13/24; G06F 3/04842

(57) ABSTRACT

Various implementations relate to methods, systems, and computer readable media for selecting user interface (UI) elements using directional input. According to one aspect, a computer-implemented method includes receiving a directional input from an input device during navigation of a UI. A determination is made, based on a direction of the directional input and position of a currently selected UI element, whether to apply a directional selection or a pointing-based selection. If the directional selection is applied, a candidate UI element is selected based on alignment and spatial proximity relative to the currently selected UI element and the directional input. If the pointing-based selection is applied, a directional raycast is performed originating from the currently selected UI element, and the candidate UI element is selected based on angular deviation and/or distance relative to the raycast direction. The selected candidate UI element is highlighted and confirmed upon release of the directional input.

### CROSS-REFERENCE TO RELATED APPLICATIONS

This application is a non-provisional patent application that claims priority under 35 U.S.C. § 119(e) to U.S. Provisional Patent Application No. 63/752,551, filed Jan. 31, 2025, and titled “SELECTION OF USER INTERFACE ELEMENTS USING ANALOG STICK-BASED INPUT”, the entire contents of which are incorporated by reference herein.

### TECHNICAL FIELD

Various implementations described herein relate generally to user interface (UI) navigation in computing devices, and more particularly but not exclusively, to methods, systems, and computer-readable media to provide selection of UI elements using directional input.

### BACKGROUND

In interactive digital environments, users navigate interfaces using directional input such as arrow keys, directional pads (d-pads), or analog sticks. These interfaces present selectable elements in a spatial layout, including menus arranged in grids, radial wheels, or layered virtual scenes. Navigation techniques rely on predefined adjacency relationships between UI elements to determine which element receives focus in response to directional input. When the user presses a directional key or moves an analog stick, the interface selects an adjacent element according to a fixed directional mapping.

While adjacency-based navigation techniques can be effective in traditional two-dimensional layouts, they may not provide intuitive results in irregular or three-dimensional (3D) UI configurations. In interfaces with non-uniform spacing, varying element sizes, or spatial depth, directional input may not correspond cleanly to a single adjacent element. This can lead to inconsistent selection behavior that frustrates the user and reduces the efficiency of navigation.

Some approaches incorporate spatial heuristics that estimate which element lies in the direction of intended navigation. These techniques compare angular offsets or distances between elements relative to a navigation vector. Ambiguous results can arise in scenarios with multiple equally plausible targets, such as densely clustered menus or overlapping layers of elements. Incorrect selection or oscillation between elements may occur, requiring the user to retry or manually reposition the navigation cursor.

Some interactive environments support pointing-based techniques, such as mouse or joystick-based raycasting, to enable users to select UI elements by directly aiming at them. These techniques may provide more precise control in some contexts but can include sustained directional input or fine motor coordination, which may not be feasible or desirable on certain input devices or in time-sensitive interactions. Fallback strategies that combine pointing-based and directional navigation may lack robust integration logic, resulting in inconsistent behavior when one technique fails to yield a valid target.

Additional shortcomings appear when dynamic or animated UI elements are involved. As UI elements move, appear, or disappear in real-time or near real-time, static directional mappings or raycast assumptions can become invalid. Without mechanisms to adapt to real-time layout changes, navigation techniques may misdirect navigation or fail to update selection targets. These limitations reduce reliability in modern dynamic interface environments that include spatial layouts, 3D positioning, or avatar-driven interaction.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to provide selection of UI elements using directional input.

According to one aspect, a computer-implemented method includes receiving a directional input from an input device during navigation of a UI. It is determined, based on a direction of the directional input and a position of a currently selected UI element, whether to apply a directional selection or a pointing-based selection. If the directional selection is applied, a candidate UI element is selected based on alignment and spatial proximity relative to the currently selected UI element and the direction of the directional input. If the pointing-based selection is applied, a directional raycast originating from the currently selected UI element is performed to obtain a raycast direction, and the candidate UI element is selected based on one or both of angular deviation and distance relative to the raycast direction. The selected candidate UI element is highlighted. A release of the directional input is detected and, in response, the currently selected candidate UI element is updated to the selected candidate UI element.

In some implementations, selecting the candidate UI element based on one or both of angular deviation and distance includes assigning a weighted score to each candidate UI element based on one or both of angle and distance relative to the raycast direction.

In some implementations, the directional selection evaluates whether a candidate UI element is aligned with a cardinal axis relative to the currently selected UI element.

In some implementations, the directional selection defines a bounding region extending outward from the currently selected UI element in the direction of the directional input.

In some implementations, candidate UI elements are filtered based on one or more attributes indicating whether the UI elements are visible and capable of receiving user interaction.

In some implementations, candidate UI elements are assigned to one or more groups based on shared layout structure or metadata, and selection is prioritized among UI elements within a same group.

In some implementations, the directional input is generated by an analog stick, and detecting the release of the directional input includes detecting that the analog stick has returned towards a neutral position.

In some implementations, the directional selection is evaluated prior to the pointing-based selection, and the pointing-based selection is applied in response to a determination that the directional selection does not identify a valid candidate UI element.

In some implementations, a region used for directional selection is adjusted based on a size of the currently selected UI element.

In some implementations, the raycast is performed in a two-dimensional plane corresponding to spatial positions of the UI elements.

In some implementations, the direction of the directional input is determined from a displacement vector generated by the input device.

According to another aspect, a computing device includes one or more processors, and memory coupled to the one or more processors with instructions stored thereon that, when executed by the one or more processors, cause the one or more processors to perform or control performance of operations including receiving a directional input from an input device during navigation of a UI. It is determined, based on a direction of the directional input and a position of a currently selected UI element, whether to apply a directional selection or a pointing-based selection. If the directional selection is applied, a candidate UI element is selected based on alignment and spatial proximity relative to the currently selected UI element and the direction of the directional input. If the pointing-based selection is applied, a directional raycast originating from the currently selected UI element is performed to obtain a raycast direction, and the candidate UI element is selected based on one or both of angular deviation and distance relative to the raycast direction. The selected candidate UI element is highlighted. A release of the directional input is detected and, in response, the currently selected candidate UI element is updated to the selected candidate UI element.

In some implementations, selecting the candidate UI element based on one or both of angular deviation and distance includes assigning a weighted score to each candidate UI element based on one or both of angle and distance relative to the raycast direction.

In some implementations, the directional selection evaluates whether a candidate UI element is aligned with a cardinal axis relative to the currently selected UI element.

In some implementations, the directional selection defines a bounding region extending outward from the currently selected UI element in the direction of the directional input.

In some implementations, candidate UI elements are filtered based on one or more attributes indicating whether the UI elements are visible and capable of receiving user interaction.

In some implementations, candidate UI elements are assigned to one or more groups based on shared layout structure or metadata, and selection is prioritized among UI elements within a same group.

In some implementations, the directional input is generated by an analog stick, and detecting the release of the directional input includes detecting that the analog stick has returned towards a neutral position.

In some implementations, the directional selection is evaluated prior to the pointing-based selection, and the pointing-based selection is applied in response to a determination that the directional selection does not identify a valid candidate UI element.

According to another aspect, a non-transitory computer-readable medium includes instructions stored thereon that, when executed by a processor, cause the processor to perform or control performance of operations including receiving a directional input from an input device during navigation of a UI. It is determined, based on a direction of the directional input and a position of a currently selected UI element, whether to apply a directional selection or a pointing-based selection. If the directional selection is applied, a candidate UI element is selected based on alignment and spatial proximity relative to the currently selected UI element and the direction of the directional input. If the pointing-based selection is applied, a directional raycast originating from the currently selected UI element is performed to obtain a raycast direction, and the candidate UI element is selected based on one or both of angular deviation and distance relative to the raycast direction. The selected candidate UI element is highlighted. A release of the directional input is detected and, in response, the currently selected candidate UI element is updated to the selected candidate UI element.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to provide selection of UI elements using directional input, in accordance with some implementations.

FIG. 2 is a flow diagram illustrating an example method to provide selection of UI elements using directional input, in accordance with some implementations.

FIG. 3A is a diagram illustrating an example of a virtual experience UI prior to a UI element selection, in accordance with some implementations.

FIG. 3B is a diagram illustrating an example of a virtual experience UI in which a directional input has been received and a raycast has been generated, prior to selection of a UI element, in accordance with some implementations.

FIG. 3C is a diagram illustrating an example of a virtual experience UI in which a new UI element has been selected and highlighted following user navigation input, in accordance with some implementations.

FIG. 3D is a diagram illustrating an example of a virtual experience UI after a directional input has been released, resulting in confirmation of a UI element selection, in accordance with some implementations.

FIG. 4 is a diagram illustrating a set of scenarios for evaluating which UI elements are valid candidates for selection in response to a downward directional input, in accordance with some implementations.

FIG. 5 is a diagram illustrating directional selection techniques that apply when a user is currently selecting a UI element, in accordance with some implementations.

FIG. 6 is a block diagram that illustrates an example computing device, in accordance with some implementations.

### DETAILED DESCRIPTION

Various implementations described herein relate to techniques for navigating a user interface (UI) using directional input combined with context-sensitive selection logic. These techniques support scenarios in which a user navigates through a collection of UI elements laid out in a spatial configuration, such as grids, lists, or irregular layouts rendered in two or three dimensions. The approach enables intelligent selection of a UI element based on the direction of input and the spatial relationship between the current UI element and candidate UI elements. In some cases, a directional selection heuristic may be applied, while in others, a pointing-based selection strategy may be used, depending on layout context and alignment criteria.

In some implementations, either a directional selection modality or a pointing-based modality is utilized based on spatial characteristics of the directional input relative to a currently selected UI element. Directional selection identifies candidate UI elements based on alignment and proximity along a canonical axis defined by the input direction. Pointing-based selection performs a raycast from the currently selected UI element and evaluates candidate UI elements based on one or both of angular deviation and distance from the raycast vector. A control flow evaluates both modalities, applying the directional strategy when an aligned candidate exists, and falling back to pointing-based logic when directional heuristics fail to yield a result. This enables navigation logic to adapt fluidly to irregular, dense, or three-dimensional layouts.

In some implementations, filtering and/or scoring strategies are utilized to refine candidate selection. Candidate UI elements may be filtered based on attributes such as visibility, user interactivity, or group metadata, and scored using weighted functions that combine angular and spatial parameters. The scoring improves the accuracy of selection in complex or clustered layouts and enables prioritization of elements that are contextually relevant. In some implementations, elements may be grouped based on layout metadata, with the selection prioritizing candidates from the same group as the current selection to improve coherence during navigation transitions.

In some implementations, the release of an analog stick input is detected in order to confirm a new selection. The techniques support analog inputs by detecting return-to-neutral behavior, so that updates to the selected UI element occur after user confirmation. This improves stability and responsiveness during navigation. By combining directional heuristics, pointing-based raycasting, candidate filtering, and input detection into a cohesive framework, the described techniques enable intuitive and reliable navigation of dynamic user interfaces across a wide range of application contexts.

Technical advantages of various features described herein include improving the accuracy and consistency of UI selection using directional inputs, in contexts such as game controllers or analog sticks where traditional pointing techniques are unavailable or unreliable. The described approach(es) enable(s) selection based on angular alignment and proximity, addressing limitations of existing techniques that rely solely on rectangular bounding boxes or grid-based layouts. This reduces incorrect selections and enhances the usability of interfaces arranged in non-rectangular or dynamic spatial configurations.

Another technical advantage of some implementations is the ability to utilize a raycast-based pointing mechanism when the directional selection fails to identify a suitable candidate. The hybrid or dual-mode techniques enable flexible adaptation to varied UI configurations and mitigates selection failures that may otherwise arise due to gaps, sparse layouts, or unconventional interface designs. The techniques enable user intent to still be captured and mapped to an relevant UI element even when a direct directional match is unavailable.

Another technical advantage of some implementations is the ability to support dynamic user interfaces, where elements may be repositioned, hidden, or made non-selectable based on context. The approach(es) enable(s) real-time filtering of UI elements based on visibility or interaction state, so that non-interactive elements are excluded from consideration during selection. This contributes to robustness in changing interface states, such as pop-up dialogs, context menus, or adaptive UI layouts.

Another technical advantage of some implementations is in continuity of interaction through confirmation of selection based on release of directional input, and automatic reassignment of origin points for subsequent selections. This reduces cognitive load on the user and streamlines sequential UI interactions, making the approach suitable for complex virtual environments, gaming interfaces, and controller-driven applications.

In the following detailed description, reference is made to the accompanying drawings, which form a part hereof. In the drawings, similar symbols identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, “aspect”, “aspects”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

### System Architecture

The present disclosure is directed towards, inter alia, techniques to provide selection of UI elements during navigation using directional input by dynamically determining whether to apply a directional selection or a pointing-based selection.

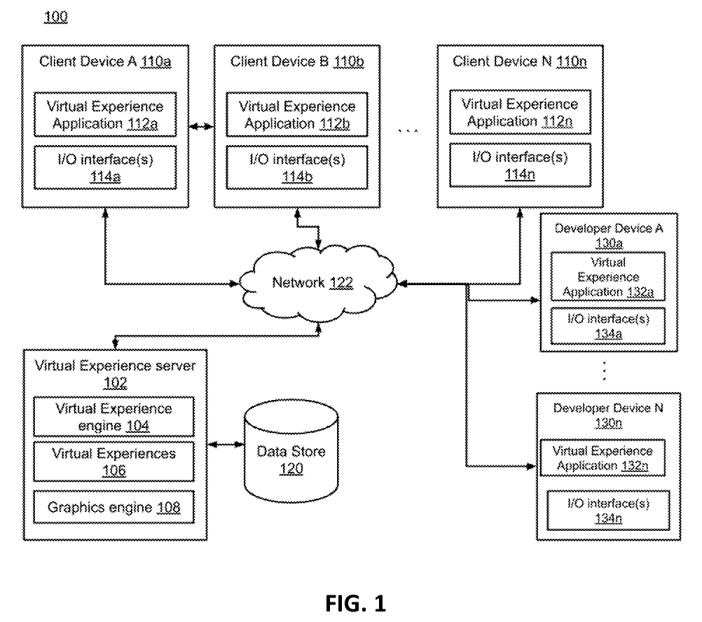

FIG. 1 is a diagram of an example system architecture to provide selection of UI elements using directional input. FIG. 1 and the other figures use like reference numerals to identify similar elements. A letter after a reference numeral, such as “110," indicates that the text refers specifically to the element having that particular reference numeral. A reference numeral in the text without a following letter, such as "110," refers to any or all of the elements in the figures bearing that reference numeral (e.g. "110" in the text refers to reference numerals “110a," “110b," and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

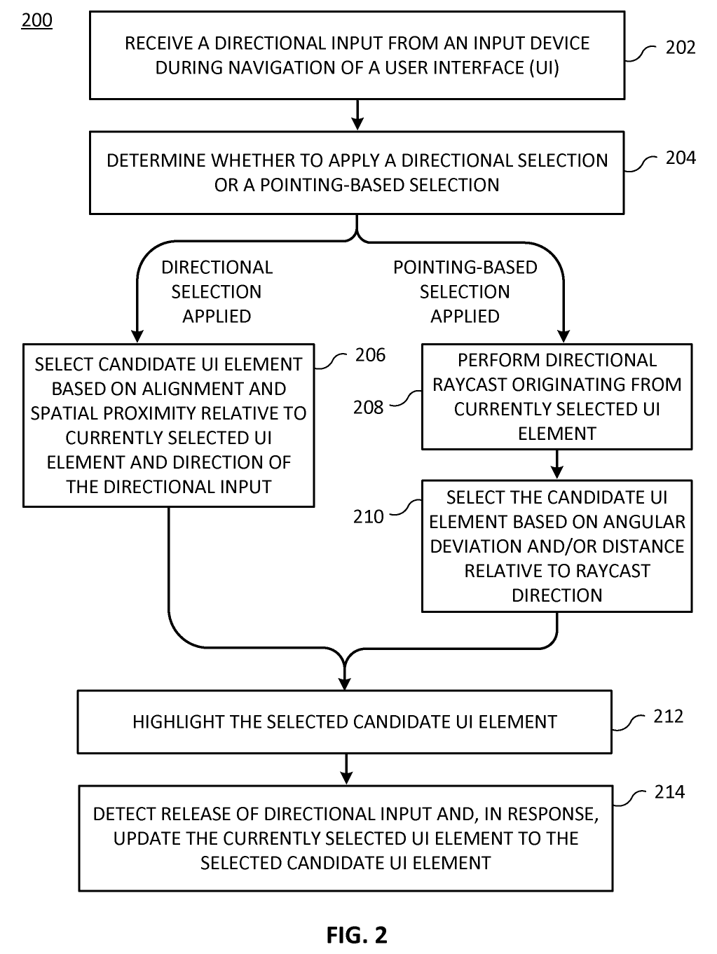

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or other component(s) of the virtual experience server 102 may perform one or more of the operations described below in connection with the flowchart shown in FIG. 2 and/or in connection with other operations described herein. In one or more additional or alternative implementations, the operations described below may be performed on one or more client devices 110, one or more developer devices 130, or other device(s) usable in the system architecture 100. In some implementations, where the operations are performed depends at least in part on computational resources (e.g., memory, processing power, or disk space). A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.” In some contexts, a “user” may include a developer, a system administrator, or other type of entity that may have capabilities, privileges, etc. that are different from those of an end user or other type of consumer.

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, augmented reality (AR) experiences, or combinations thereof, for example. In some implementations, users may participate in interactions (such as gameplay) with other users. In some implementations, a virtual experience may be experienced in real-time or near-real-time with other users of the virtual experience. References herein to a game (and related gaming functionality) are for purposes of example and illustration of various features. The various features can be adapted to other types of virtual experiences/environments that do not necessarily involve games.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 and/or other component(s) of the virtual experience server 102, client device 110, developer device 130, or other device(s) usable in the system architecture 100 may implement the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.). In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine and virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or avatar position and velocity information, etc.) to the online virtual experience server 102. Subsequent to receiving control instructions from the client devices 110, the online virtual experience server 102 may send experience instructions (e.g., position and velocity information of the avatars participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (e.g., avatar) of the user within the virtual experience. For example, control instructions may include user input to control action within the experience, such as right, left, up, down, user selection, gyroscope position and orientation data, force sensor data, etc. The control instructions may include avatar position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, avatars (or virtual experience objects generally) are constructed from components, one or more of which may be selected by the user, that automatically join together to aid the user in editing.

In some implementations, an avatar is implemented as a 3D model and includes a surface representation used to draw the avatar (also known as a skin or mesh) and a hierarchical set of interconnected bones (also known as a skeleton or rig). The rig may be utilized to animate the avatar and to simulate motion and action by the avatar. The 3D model may be represented as a data structure, and one or more parameters of the data structure may be modified to change various properties of the avatar (e.g., dimensions (height, width, girth, etc.); body type; movement style; number/ type of body parts; proportion (e.g., shoulder and hip ratio); head size; etc.).

One or more avatars (also referred to as a “character” or “model” herein) may be associated with a user where the user may control the avatar to enable an interaction of the user with the virtual experience 106.

In some implementations, an avatar may include components such as body parts (e.g., hair, arms, legs, etc.) and accessories (e.g., t-shirt, glasses, decorative images, tools, etc.). In some implementations, body parts of avatars that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.) the online virtual experience platform may provide users access to simplified 3D virtual object models that are represented by a mesh of a low polygon count (e.g., between about 20 and about 30 polygons).

In some implementations, the user may control the scale (e.g., height, width, or depth) of an avatar or the scale of components of an avatar. In some implementations, the user may control the proportions of an avatar (e.g., blocky, anatomical, etc.). It may be noted that in some implementations, an avatar may not include an avatarvirtual experience object (e.g., body parts, etc.) but the user may control the avatar (without the avatar virtual experience object) to enable the interaction of the user with the virtual experience (e.g., a puzzle game where there is no rendered avatar game object, but the user still controls an avatar to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish an avatar of a user for view or use by other users of the online virtual experience server 102. In some implementations, creating, modifying, or customizing avatars, other virtual experience objects, virtual experiences 106, or virtual experience environments may be performed by a user using an I/O interface (e.g., developer interface) and with or without scripting (or with or without an application programming interface (API)). It may be noted that for purposes of illustration, avatars are described as having a humanoid form. It may further be noted that avatars may have any form such as a vehicle, animal, animate or inanimate object, or other creative form.

In some implementations, the online virtual experience server 102 may store avatars created by users in the data store 120. In some implementations, the online virtual experience server 102 maintains an avatar catalog and virtual experience catalog that may be presented to users. In some implementations, the virtual experience catalog includes images of virtual experiences stored on the online virtual experience server 102. In addition, a user may select an avatar (e.g., an avatar created by the user or other user) from the avatar catalog to participate in the chosen virtual experience. The avatar catalog includes images of avatars stored on the online virtual experience server 102. In some implementations, one or more of the avatars in the avatar catalog may have been created or customized by the user. In some implementations, the chosen avatar may have avatar settings defining one or more of the components of the avatar.

In some implementations, an avatar of a user can include a configuration of components, where the configuration and appearance of components and more generally the appearance of the avatar may be defined by avatar settings. In some implementations, the avatar settings of an avatar of a user may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application 112 may be a web application (e.g., an application that operates in conjunction with a web browser) that can access, retrieve, present, or navigate content (e.g., virtual avatar in a virtual experience, etc.) served by a web server. In another example, the virtual experience application 112 may be a native application (e.g., a mobile application, app, virtual experience program, or a gaming program) that is installed and executes local to client device 110 and enables users to interact with online virtual experience server 102. The virtual experience application 112 may render, display, or present the content (e.g., a web page, a media viewer) to a user. In an implementation, the virtual experience application 112 may include an embedded media player that is embedded in a web page.

According to aspects of the disclosure, the virtual experience application 112 may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application 112 may be provided to the client device(s) 110 by the online virtual experience server 102. In another example, the virtual experience application 112 may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application 132 may be a web application (e.g., an application that operates in conjunction with a web browser) that can access, retrieve, present, or navigate content (e.g., virtual avatar in a virtual experience, etc.) served by a web server. In another example, the virtual experience application 132 may be a native application (e.g., a mobile application, app, virtual experience program, or a gaming program) that is installed and executes local to developer device 130 and enables users to interact with online virtual experience server 102. The virtual experience application 132 may render, display, or present the content (e.g., a web page, a media viewer) to a user. In an implementation, the virtual experience application 132 may include an embedded media player that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application 132 may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application 112/132. The user may access a user account by providing user account information (e.g., username and password) where the user account is associated with one or more avatars available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, a virtual platform server (e.g., virtual experience engine 104 and/or other component(s) of the virtual experience server 102) includes an interface selection component configured to interpret directional input signals, such as those generated by an analog stick or similar/analogous input mechanism, for navigation across user interface elements. The interface selection component may apply the techniques described herein, including determining whether a directional input falls within a directional selection region, applying directional selection logic based on alignment and proximity, and selectively falling back to a pointing-based selection involving directional raycasting and evaluation of one or both of angular deviation and distance. By executing these operations server-side or platform-side, selection behavior can remain consistent across different client devices while offloading processing from the client.

Client devices (e.g., 110) may execute a platform application, game client, or browser-based interface that transmits directional input signals and receives updated selection state data from the platform. In some implementations, the client device may provide the current position of the analog stick, a current origin point, and other contextual signals to the platform, which returns a selected UI element identifier. Alternatively or additionally, the client device may perform the full selection evaluation locally using platform-provided configuration data, such as selection regions or scoring weights. In either configuration, the client may handle display-related operations such as rendering selection highlights, animations, or feedback indicators based on the selection logic results, while ensuring that the underlying selection is consistent with the platform logic.

### Selection of UI Elements Using Directional Input

FIG. 2 is a flow diagram illustrating an example method 200 to provide selection of UI elements using directional input, in accordance with some implementations.

In various implementations, the blocks shown in FIG. 2 and described below may be performed by any of the computing devices illustrated in FIG. 1, for example, by one or more of client devices 110 and/or online virtual experience server 102 and/or other device(s) usable in the system architecture 100. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, a directional input is received from an input device during navigation of a UI. A directional input includes an input signal that conveys an intended movement direction along one or more axes. In some implementations, the directional input may include analog or digital representations of direction, such as vector displacements or discrete directional signals. Examples of input devices that may generate directional input include an analog stick or joystick on a game controller, a d-pad, arrow keys on a keyboard, or touch-based directional gestures on a touchscreen. The directional input may be represented as a displacement vector, a unit vector, or a discrete directional indicator corresponding to an intended direction of focus or interaction within the UI.

In some implementations, an input device includes any physical or virtual component through which a user provides input to a computing device. Input devices may include game controllers, keyboards, mice, touchscreens, trackpads, or any combination thereof. In some implementations, the input device comprises a joystick or thumbstick capable of generating two-dimensional displacement vectors corresponding to user movement. In other implementations, input devices may generate digital inputs corresponding to fixed directions, such as up, down, left, or right signals. The type of input device and its characteristics may influence the processing of directional input in subsequent steps.

In some implementations, the directional input may be captured by the platform in real-time or near real-time during the course of UI navigation. Navigation includes the process of traversing or interacting with elements presented within a user interface, including movement of focus between UI elements, activation of elements, or other state transitions. Navigation may occur within menus, selection screens, configuration panels, or other graphical interface structures. The directional input enables the user to guide navigation by indicating a preferred direction of movement from a currently selected or focused UI element.

In some implementations, a UI includes the visual layout of interactive elements presented to the user on a display. UI elements may include buttons, icons, panels, toggles, sliders, or other graphical components capable of receiving user interaction. The UI may be presented in two dimensions or three dimensions and may be structured as a hierarchy, grid, flow layout, or arbitrary spatial arrangement. Each UI element may be associated with a bounding region and spatial coordinates used in selection processing. The described techniques support interfaces where navigation is performed through directional input rather than freeform pointer movement.

In some implementations, the directional input is received as part of a continuous input stream and is sampled at a regular interval to determine whether a navigation operation may be initiated. For example, a displacement vector of an analog stick may be monitored continuously, and a navigation trigger may occur when the vector magnitude meets a threshold. In other implementations, the directional input is treated as an event, such as a key press or digital signal transition. The platform may normalize directional input to a common representation for subsequent evaluation regardless of the originating input device.

In some implementations, the received directional input is associated with a point of origin corresponding to a currently selected UI element. The currently selected UI element may be determined based on prior interaction history, default layout logic, or an initial focus state of the UI. The point of origin provides a reference frame for interpreting the direction of the input and determining candidate UI elements in the intended direction. Processing of the directional input includes evaluating the direction, comparing the direction against spatial positions of UI elements, and selecting a next UI element based on selection logic described in subsequent blocks. Block 202 is followed by block 204.

At block 204, it is determined, based on a direction of the directional input and a position of a currently selected UI element, whether to apply a directional selection or a pointing-based selection. In some implementations, a direction of the directional input includes an orientation or vector indicating an intended movement direction within the UI. In some implementations, the direction may be expressed as a normalized vector derived from an analog stick displacement, a discrete directional signal corresponding to a key press, or another representation indicating a heading relative to the UI layout.

A position of a currently selected UI element includes spatial information indicating where the currently selected UI element is located within the UI. In various implementations, the position may be represented using two-dimensional coordinates in screen space, layout-relative coordinates within a container, or projected coordinates in a three-dimensional interface. The position of the currently selected UI element serves as a reference point from which candidate UI elements are evaluated in subsequent selection processing.

A currently selected UI element includes a UI element that is designated as active, focused, or highlighted at a given time during navigation. In various implementations, the currently selected UI element may be identified based on a prior selection event, an initial focus assignment when the UI is rendered, or a previously confirmed navigation action. The currently selected UI element defines the origin for evaluating directional relationships between UI elements during navigation.

In some implementations, determining whether to apply a directional selection or a pointing-based selection includes evaluating spatial characteristics derived from the direction of the directional input relative to the position of the currently selected UI element. In some implementations, the determination may include determining whether the direction aligns with an axis, region, or spatial corridor extending from the currently selected UI element, or whether the direction indicates freeform pointing behavior that does not correspond to a directional region.

In some implementations, a directional selection includes selecting a candidate UI element based on directional alignment and relative spatial proximity along a direction indicated by the directional input. In this process, candidate UI elements may be evaluated based on whether they fall within a directional region extending outward from the currently selected UI element, such as a rectangular, angular, or sector-based region. The directional selection may prioritize UI elements that are aligned along a horizontal or vertical axis relative to the currently selected UI element.

In some implementations, a pointing-based selection includes selecting a candidate UI element using a raycast or similar projection originating from the position of the currently selected UI element and extending along the direction of the directional input. Candidate UI elements may be evaluated based on intersection with the projected ray or based on one or both of angular deviation and distance relative to the ray direction. The pointing-based selection enables selection behavior that more closely corresponds to pointing or aiming interactions within the UI when directional alignment criteria are not satisfied.

In some implementations, the directional selection is evaluated prior to the pointing-based selection, and the pointing-based selection is applied in response to a determination that the directional selection does not identify a valid candidate UI element. The evaluation includes computing whether any UI elements fall within the expected directional region relative to the currently selected UI element and the input direction. If no candidates satisfy the directional selection criteria, such as axis alignment or bounding region intersection, the pointing-based selection is triggered as a fallback.

In some implementations, the direction of the directional input is determined from a displacement vector generated by the input device. The displacement vector includes a directional component derived from the change in position or pressure applied through the input device, such as an analog stick, trackpad, or touch input. For example, in the case of an analog stick, the vector may be formed from the horizontal and vertical axis offsets relative to a neutral center position, producing a two-dimensional vector pointing in the intended navigation direction. The directional vector is used to evaluate whether the input aligns with a directional selection region or whether it may initiate a pointing-based selection.

If the directional selection is applied, block 204 is followed by block 206. If the pointing-based selection is applied, block 204 is followed by block 208.

At block 206, if the directional selection is applied, a candidate UI element is selected based on alignment and spatial proximity relative to the currently selected UI element and the direction of the directional input. The directional selection is applied if the direction of the directional input falls within a directional region extending from the currently selected UI element, where the directional region includes a portion of the UI space positioned in line with the input direction and anchored at the location of the currently selected UI element. The evaluation includes identifying candidate UI elements that are positioned in the direction indicated by the directional input.

Alignment includes a measure of how closely a candidate UI element is oriented with respect to the direction of the directional input. In some implementations, alignment may be determined by comparing an angle between a vector from the currently selected UI element to the candidate UI element and the directional input vector. For example, a candidate UI element positioned directly above the currently selected UI element may be considered aligned with an upward directional input, while a diagonally positioned element may be considered less aligned depending on angular deviation.

Spatial proximity includes a measure of distance between the currently selected UI element and a candidate UI element. In various implementations, the distance may be computed using Euclidean distance in two-dimensional screen space, layout-relative coordinates, or projected coordinates in a three-dimensional interface. In some implementations, candidate UI elements that are closer in distance to the currently selected UI element may be assigned higher priority than elements that are farther away, provided alignment criteria are satisfied.

The currently selected UI element includes the UI element that serves as a reference point for evaluating candidate UI elements during navigation. In some implementations, the position of the currently selected UI element establishes an origin from which directional relationships and distances are calculated. For example, if a button is currently selected in a vertical menu, the position of that button defines the origin for evaluating other buttons located above or below it.

In some implementations, selecting a candidate UI element includes identifying one UI element from a set of candidate UI elements that best satisfies alignment and spatial proximity criteria. In some implementations, multiple candidate UI elements may fall within a directional region defined by the directional input. In some implementations, a scoring function may be applied that combines alignment and distance values to rank the candidates and select the highest-ranked UI element.

In some implementations, the direction of the directional input includes a vector or orientation derived from the input device that indicates an intended navigation direction. The direction may be normalized to remove magnitude effects and focus evaluation on orientation. The directional selection uses this direction to constrain candidate UI elements to those that lie within a directional region extending outward from the currently selected UI element, such as a corridor, cone, or sector aligned with the directional input.

In some implementations, the directional selection evaluates whether a candidate UI element is aligned with a cardinal axis relative to the currently selected UI element. Each cardinal axis includes a principal direction such as up, down, left, or right defined in a coordinate system associated with the user interface. The directional input is used to identify a corresponding cardinal direction of intended navigation. Candidate UI elements are evaluated to determine whether their spatial positions fall along the identified axis extending from the currently selected UI element, subject to one or more positional tolerances or alignment thresholds. For example, if the directional input indicates upward movement, candidate UI elements positioned above the currently selected UI element and within a vertical alignment range may be considered aligned and prioritized for selection.

In some implementations, the directional selection defines a bounding region extending outward from the currently selected UI element in the direction of the directional input. In some implementations, the bounding region includes a spatial zone that originates from the boundary or center point of the currently selected UI element and expands along the directional vector of the input. The region may include a rectangular strip, wedge-shaped sector, or other geometric area that delimits which candidate UI elements are included for consideration. For example, if the directional input indicates movement toward the right, the bounding region may extend horizontally to the right of the currently selected UI element with a defined vertical tolerance, enabling detection of rightward-aligned candidates that are slightly offset from the horizontal axis.

In some implementations, prior to evaluating candidate UI elements for alignment and spatial proximity, the directional selection filters the candidate set based on one or more attributes that indicate eligibility for selection. Each candidate UI element may include metadata or runtime flags describing its current visibility and ability to receive user interaction. For example, UI elements that are hidden, offscreen, or disabled for input handling are removed from the candidate

pool. The filtering enables the directional selection logic, such as bounding region intersection or axis alignment, to only operate on elements that are visually present and active within the interface layout, thereby preventing invalid elements from being selected based on spatial proximity alone.

In some implementations, candidate UI elements are assigned to one or more groups based on shared layout structure or associated metadata, and selection is prioritized among UI elements that belong to the same group. Grouping may be based on spatial alignment, such as UI elements that lie on the same row or column, or based on metadata labels indicating a common functional category. During directional navigation, when multiple candidates fall within a selection region, the directional selection may first evaluate candidates that share a group with the currently selected UI element before considering others. For example, if a user is navigating a grid of buttons organized into rows, left and right movement may prioritize transitions within the same row.

In some implementations, the region used for directional selection is adjusted based on a size of the currently selected UI element. The size may include dimensions such as width, height, or overall dimensions of the currently selected UI element in the UI layout. The directional selection region may be expanded or contracted in proportion to these dimensions to account for variations in element size. For example, a larger UI element may result in a wider directional region to accommodate its visual footprint, while a smaller element may result in a narrower region to maintain precise navigation behavior. Block 206 is followed by block 212.

At block 208, if the pointing-based selection is applied, a directional raycast originating from the currently selected UI element is performed to obtain a raycast direction. The raycast is used to determine whether a candidate UI element lies along the direction indicated by the directional input. A raycast includes a computational process that extends a virtual line, or ray, from a defined origin point along a particular direction in a two-dimensional coordinate space associated with the user interface. In some implementations, the origin point corresponds to the coordinates of the currently selected UI element, and the direction is derived from the directional input received from the input device.

In some implementations, the raycast may be configured to detect intersections between the projected ray and bounding boxes or geometric outlines of other UI elements that are spatially represented on the same coordinate plane. UI elements may include, for example, buttons, icons, tabs, or other interactive regions within the interface that are configured to receive user input. By projecting a ray from the position of the currently selected UI element along the vector determined by the directional input, it is determined whether the ray intersects any UI elements positioned in the path of the ray. The first intersected element along the ray direction may be designated as the selected UI element for highlighting and potential activation.

In some implementations, the direction of the raycast is based on the direction of the directional input, which may be computed as a unit vector derived from the displacement vector of the analog stick or other directional control. The direction vector determines the angle at which the ray is projected from the origin point. In some implementations, the ray may be discretized into sampling intervals or checked against a spatial resolution to optimize performance and accuracy when determining intersections with UI elements. The projection may account for the dimensions or shape of the currently selected UI element to determine the exact starting point of the raycast.

In some implementations, if the raycast intersects with the bounding area of a UI element, that UI element may be identified as a potential selection candidate. In some implementations, multiple UI elements may lie along or near the path of the raycast. In such situations, additional evaluation criteria may be applied to determine which candidate may be selected. For example, proximity to the ray direction or angular deviation from the central axis of the ray may be used to resolve ambiguity.

In some implementations, in scenarios where no UI elements are intersected by the raycast, alternative logic may be invoked to select a fallback candidate. This may include selecting a candidate based on angular closeness to the ray direction and spatial proximity to the origin point, using a scoring function that weighs these factors. Such fallback logic supports robust selection behavior even in sparse or irregularly structured UI layouts, where elements may not be perfectly aligned along clean directional paths. The fallback mechanism helps maintain selection continuity and responsiveness in the absence of direct intersection results from the raycast.

In some implementations, raycasting acts as a directional extension of the navigation input of the user, enabling selection decisions to be made based on projected direction rather than strict alignment. By combining spatial projection with intersection testing and proximity evaluation, the pointing-based selection enables interaction with UI elements positioned at arbitrary angles or offsets from the currently selected UI element. In some implementations, this supports flexible navigation in user interfaces that are non-grid-based or spatially varied.

In some implementations, the raycast is performed in a two-dimensional plane corresponding to the spatial positions of the UI elements. The two-dimensional plane includes a coordinate space in which the positional attributes of the UI elements are defined, such as screen-space coordinates or a layout-defined grid. The raycast is generated as a vector extending from the currently selected UI element in the direction of the directional input, constrained to operate within the same plane in which UI elements are arranged for interaction. For example, in a screen-based UI where all selectable elements are rendered in a flat layout, the raycast operates in that planar coordinate system rather than extending into a three-dimensional volume. Block 208 is followed by block 210.

At block 210, the candidate UI element is selected based on one or both of angular deviation and distance relative to the raycast direction. In some implementations, when a pointing-based selection is used, the candidate UI element is selected based on spatial metrics computed with respect to the direction of a previously performed raycast. In some implementations, the selection includes identifying UI elements that either intersect the raycast or are positioned close to its path, and evaluating their suitability using one or both of angular deviation and distance. In some implementations, these metrics are used to quantify how closely aligned a candidate is with the intended direction of navigation.

In some implementations, angular deviation includes the absolute angular difference between the raycast direction and a vector pointing from the origin of the raycast (e.g., the currently selected UI element) to the position of a candidate UI element. A smaller angular deviation indicates a candidate that is more directionally aligned with the intended input of the user. For example, if the raycast direction points directly upward and a candidate lies at a 10-degree offset from vertical, that candidate may be considered more relevant than one at a 45-degree offset.

In some implementations, distance includes the spatial separation between the raycast origin and the candidate UI element. In some implementations, this may be computed as Euclidean distance between the center point of the origin UI element and the center point of the candidate. In some implementations, distance is used as a secondary ranking criterion, such that among candidates with comparable angular alignment, the one that is closer is selected. Alternatively or additionally, distance may be used in combination with angular deviation in a scoring function.

In some implementations, a weighted scoring function may be defined that assigns a score to each candidate UI element as a function of one or both of angular deviation and distance. The function may give more weight to angular alignment in certain layouts or prioritize distance in interfaces where elements are evenly spaced. In various implementations, the relative weighting can be statically defined or dynamically adjusted based on contextual layout properties. In some implementations, candidate UI elements may be excluded entirely from consideration if their angular deviation meets a threshold or if their distance falls outside a maximum selection radius.

In some implementations, if multiple candidate UI elements receive valid scores, the candidate UI element with the highest score (i.e., lowest angular deviation and/or closest distance) is selected as the next UI element. If no candidate scores meet a threshold, no selection may be made and the currently selected UI element may remain unchanged.

In some implementations, selecting a candidate UI element based on one or both of angular deviation and distance includes assigning a weighted score to each candidate UI element based on one or both of angle and distance relative to the raycast direction. In some implementations, the weighted score may be derived by combining an angular deviation value, which represents an angular difference between the raycast direction and a vector from the raycast origin to the candidate UI element, with a distance value representing spatial separation between the raycast origin and the candidate UI element. In some implementations, each component may be normalized and multiplied by a corresponding weight to reflect relative importance. In some implementations, the resulting weighted score is used to rank candidate UI elements, with lower scores indicating closer alignment with the raycast direction and proximity to the raycast origin.

In some implementations, when selecting a UI element based on one of both of angular deviation and distance relative to a raycast direction, the candidate set is first filtered to exclude elements that are not visible or are not configured to accept user interaction. The filtering operation uses attributes associated with each UI element, such as a visibility flag, clipping status, or input-enabled indicator. The filtering precedes the scoring function that evaluates one or both of angle and distance, enabling the pointing-based selection to operate only on valid targets. By removing ineligible elements early in the computation, the selection avoids assigning scores to elements that may not be interactable under the current UI state. Block 210 is followed by block 212.

At block 212, the selected candidate UI element is highlighted. In some implementations, once a candidate UI element has been selected through either the directional selection or the pointing-based selection, a visual indication is applied to the selected element to reflect its current focus state. In some implementations, highlighting includes applying a distinct graphical treatment to the selected candidate UI element to differentiate it from non-selected elements. In some implementations, this may include modifying a border, a background color, a shadow, opacity, scale, or other visual attributes of the selected candidate UI element. For example, a button may appear with a glowing border or slightly enlarged frame when highlighted, signaling to the user that it is the current selection target.

In some implementations, highlighting (or other change in audiovisual state) may be updated in real-time or near real-time as the user continues to provide directional input, enabling the selected element to change dynamically as navigation continues. In some implementations, only one UI element may be highlighted at any given time. The highlighting state may be maintained internally within the navigation logic and used to determine which element will be activated if the user confirms the selection (e.g., by releasing the analog stick or pressing a selection button). The highlighting operation does not itself activate or trigger associated functionality of the UI element, but acts as a visual cue to guide user interaction. Block 212 is followed by block 214.

At block 214, a release of the directional input is detected and, in response, the currently selected UI element is updated to the selected candidate UI element. In some implementations, the navigation component monitors the state of the input device to detect when the directional input ceases. For example, for analog sticks, this includes detecting when the input returns to a neutral position, while for digital input sources such as directional pads or arrow keys, this includes detecting the transition from a pressed to an unpressed state. The release event signifies that the user has completed the input gesture, and no further directional intent is being conveyed at that moment.

Upon detecting the release of the directional input, the previously highlighted UI element is designated as the new currently selected candidate UI element. In some implementations, this update affects the internal navigation context such that subsequent directional inputs are interpreted relative to the new selection.

In some implementations, the directional input is generated by an analog stick of a game controller or other device, and detecting the release of the directional input includes detecting that the analog stick has returned towards a neutral position. In some implementations, the neutral position includes a resting state of the analog stick in which displacement along one or more axes falls below a threshold magnitude. During navigation, the platform monitors the analog stick displacement vector and determines that the directional input has been released when the vector magnitude decreases toward the neutral position. This detection is used as a signal that the user has completed a navigation gesture, triggering an update of the currently selected UI element based on the previously highlighted selection.

In some implementations, one or more of blocks 202-214 may be performed by one or more server devices, and one or more of blocks 202-214 may be performed by one or more client devices. In some implementations, all of method 200 may be performed by a server device, or by a client device. In some implementations, one or more of blocks 202-214 may be performed in parallel. Various blocks may be omitted, combined, modified, supplemented with additional blocks, performed in a different order than depicted in FIG. 2, etc.

Some implementations may include the use of user interaction data, such as navigation behavior, directional input patterns, UI element selection sequences, or device configuration details. When such data is used, it is collected in accordance with applicable privacy laws and subject to user consent. Collection is limited to information necessary for supporting selection logic refinement, input interpretation tuning, layout configuration testing, or training models that evaluate directional versus pointing-based input transitions. Identifying information may be removed or anonymized prior to analysis, with retained data restricted to non-identifiable interaction metadata involved for system performance. Data may be stored only for durations necessary for evaluation or training purposes. Users may be provided with mechanisms to manage data collection preferences, review stored input traces or layout state data, or request deletion of associated records from persistent storage.

In various implementations, the techniques described herein may include combinations of one or more features recited in the claims. For example, in some implementations, a computer-implemented method includes receiving a directional input from an input device during navigation of a UI; determining, based on a direction of the directional input and a position of a currently selected UI element, whether to apply a directional selection or a pointing-based selection; if the directional selection is applied, selecting a candidate UI element based on alignment and spatial proximity relative to the currently selected UI element and the direction of the directional input; if the pointing-based selection is applied: performing a directional raycast originating from the currently selected UI element to obtain a raycast direction, and selecting the candidate UI element based on one or both of angular deviation and distance relative to the raycast direction; highlighting the selected candidate UI element; and detecting a release of the directional input and, in response, updating the currently selected candidate UI element to the selected UI element.

In some implementations, selecting the candidate UI element based on one or both of angular deviation and distance includes assigning a weighted score to each candidate UI element based on one or both of angle and distance relative to the raycast direction. In some implementations, the directional selection evaluates whether a candidate UI element is aligned with a cardinal axis relative to the currently selected UI element. In some implementations, the directional selection defines a bounding region extending outward from the currently selected UI element in the direction of the directional input. In some implementations, the technique further comprises filtering candidate UI elements based on one or more attributes indicating whether the UI elements are visible and capable of receiving user interaction.

In some implementations, the technique includes assigning candidate UI elements to one or more groups based on shared layout structure or metadata, and prioritizing selection among UI elements within a same group. In some implementations, the directional input is generated by an analog stick, and detecting the release of the directional input comprises detecting that the analog stick has returned towards a neutral position. In some implementations, the directional selection is evaluated prior to the pointing-based selection, and the pointing-based selection is applied in response to a determination that the directional selection does not identify a valid candidate UI element. In some implementations, the technique further comprises adjusting a region used for directional selection based on a size of the currently selected UI element. In some implementations, the raycast is performed in a two-dimensional plane corresponding to spatial positions of the UI elements. In some implementations, the direction of the directional input is determined from a displacement vector generated by the input device.

Further implementations include combinations of the foregoing features. For example, an implementation may include receiving the directional input and determining which selection type to apply, where the pointing-based selection includes assigning a weighted score to each candidate UI element based on one or both of angle and distance relative to the raycast direction. Another implementation may combine directional selection features such as evaluation for cardinal axis alignment and the use of a bounding region extending outward from the currently selected UI element. Additional implementations may include filtering candidate UI elements based on visibility and interactivity, with optional grouping based on layout structure or metadata, and prioritization within each group. Implementations may also include use of an analog stick as the input device, with the release event detected by return to the neutral position. Some implementations prioritize directional selection and fall back to pointing-based selection upon failure to identify a valid candidate. Other implementations include adjustment of directional selection regions based on the size of the currently selected element, raycasting within a two-dimensional plane, and computation of directional input from a displacement vector generated by the input device. Each of these combinations may be implemented independently or together in varying permutations, depending on the desired navigation behavior.

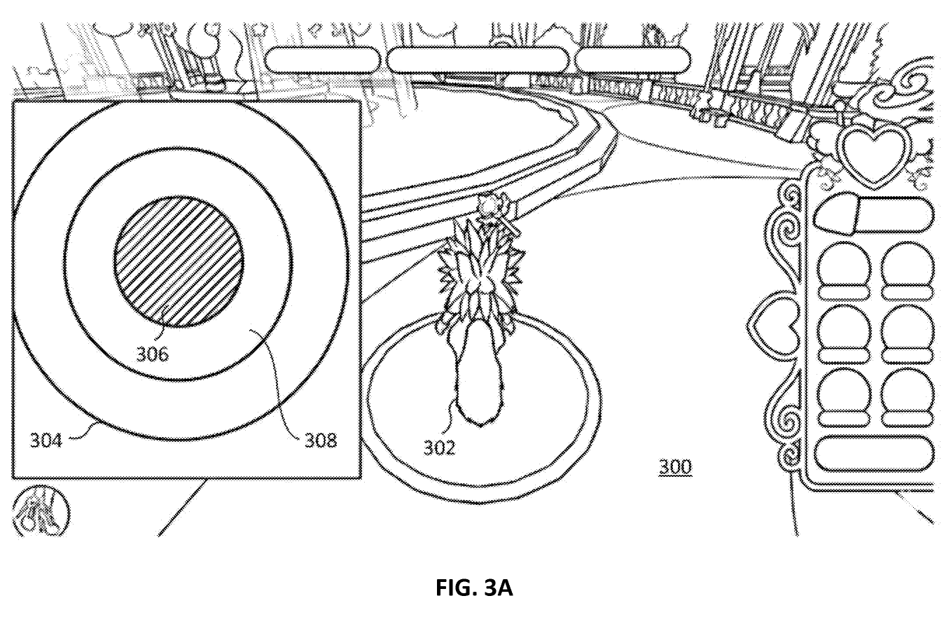

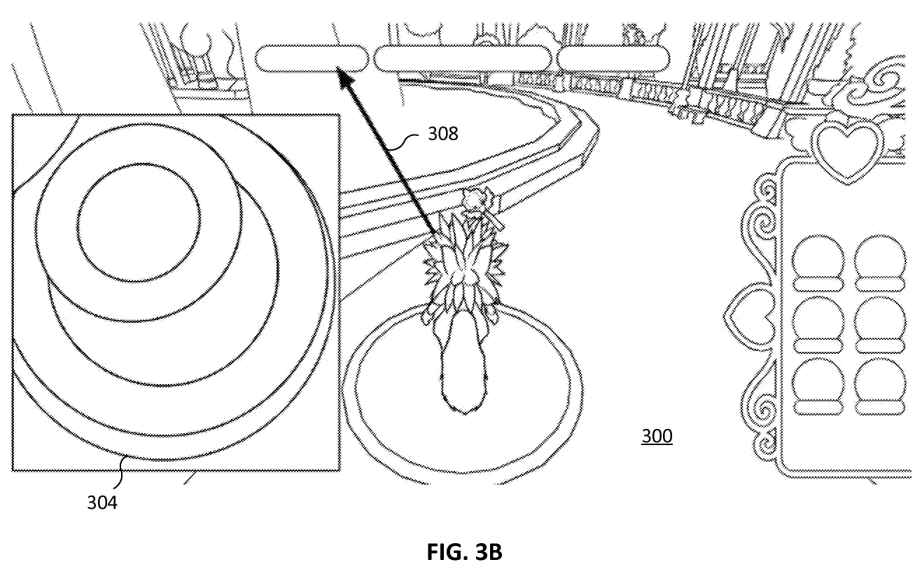

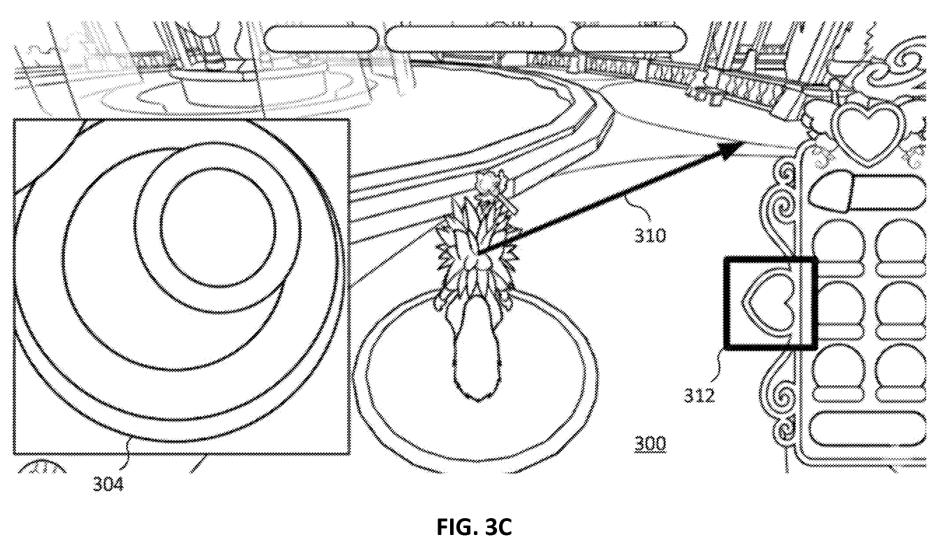

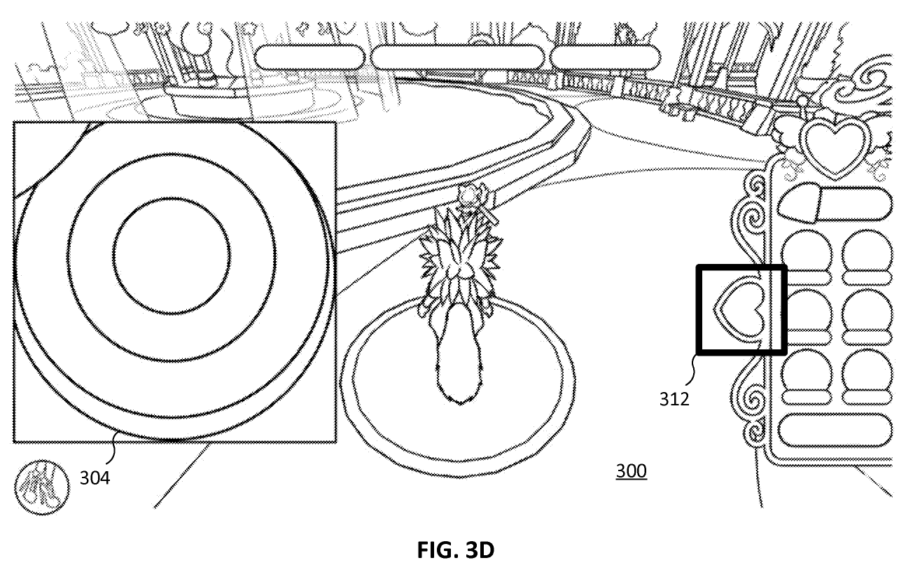

FIG. 3A is a diagram illustrating an example of a virtual experience UI prior to a UI element selection, in accordance with some implementations. The figure shows a view of a virtual environment 300 presented to a user operating a client device. The virtual environment 300 includes interactive UI elements rendered as part of a gameplay or other type of virtual experience session. The user controls an avatar 302, which is depicted near the center of the screen standing in an open region of the virtual environment 300. The avatar 302 represents the in-experience presence of the user, and may be maneuvered or positioned in the virtual space via input controls such as a keyboard, game controller, or touchscreen interface.

On the right side of the virtual environment 300, a collection of selectable UI elements is shown, representing a UI panel or menu that may contain interactive controls, inventory slots, or option selections. The user may navigate to and select from among these UI elements using a directional input device.

In the lower-left inset of FIG. 3A, an analog stick 304 is shown. The analog stick 304 represents a joystick or similar control mechanism of a game controller that enables continuous directional input in multiple directions. The analog stick 304 is depicted in a top-down view, visualizing its displacement regions as concentric rings. The outermost region corresponds to maximum displacement, while the center region reflects a neutral or resting position. In the current example, the analog stick has not yet been manipulated by the user, and therefore the analog stick is in a neutral or resting position.

A deadzone 306 is illustrated as a stationary circular region with a diagonal stripe pattern within the analog stick 304. The deadzone 306 defines a range of small displacements near the neutral position of the analog stick that are disregarded to prevent unintended navigation or jitter. A thumbstick 308 represents the movable portion of the analog stick that responds to user input. The deadzone 306 functions as a threshold for directional input. Movement of the thumbstick 308 is not considered directional input unless the center of the thumbstick 308 moves beyond the boundary of the deadzone 306. In some implementations, the deadzone threshold is configurable and may be adjusted based on sensitivity preferences or device calibration.

At the moment depicted in FIG. 3A, no UI element has been selected. The user may initiate navigation by moving the analog stick 304 outside the deadzone 306, which triggers directional input processing. Based on the direction and magnitude of the input, the system determines which selection logic to apply (e.g., either directional or pointing-based) and computes candidate UI elements accordingly. The selected candidate UI element, once determined, may be highlighted for visual feedback prior to confirmation via input release.

FIG. 3B is a diagram illustrating an example of a virtual experience UI in which a directional input has been received and a raycast has been generated, prior to selection of a UI element, in accordance with some implementations. The figure again depicts a view of the virtual environment 300, where the avatar 302 remains centrally located within the rendered scene. A collection of UI elements is presented in a horizontal arrangement along the top portion of the interface, and a separate panel of UI elements remains visible on the right-hand side.

The inset again shows the analog stick 304, now displaced outward from the center, indicating that a directional input has been initiated. The movement meets the threshold associated with the neutral position, and the input is thus treated as an intentional navigation gesture. At this stage, the navigation logic has not yet resolved a selection.

In response to the directional input, the system generates a raycast 308, shown symbolically (but not visible to a viewer) as a line extending from the currently selected UI element (associated with the avatar 302) toward the direction of the input. The raycast 308 traverses the two-dimensional plane corresponding to the spatial layout of the UI and is used to evaluate whether any candidate UI elements lie along its path. The raycast forms part of the pointing-based selection.

Although the raycast 308 intersects one of the horizontal UI elements in the top portion of the screen, no UI element has been selected or highlighted yet. The depiction represents an intermediate state in which the input has been registered and directional geometry has been computed, but the selection decision has not yet been finalized. The system may continue to track user input—such as whether the input is held, refined, or released—before confirming a selection.

The configuration illustrates the initiation of a pointing-based selection that may occur if the directional selection fails to identify a valid candidate. The raycast and candidate scoring logic described in other portions of the specification may be invoked, but no final UI interaction has occurred yet. The figure highlights the transition state between user intent and actionable UI selection.

FIG. 3C is a diagram illustrating an example of a virtual experience UI in which a new UI element has been selected and highlighted following user navigation input, in accordance with some implementations. The figure shows a continuation of the interaction depicted in FIGS. 3A and 3B within the virtual environment 300, where the avatar 302 remains centrally located. A UI composed of selectable UI elements is visible on the right-hand side of the screen.

As shown in the inset, the analog stick 304 remains displaced, indicating that directional input is still active. The direction of the analog stick displacement has changed relative to the previous input shown in FIG. 3B. The updated input vector meets the deadzone threshold and points in a new direction, resulting in a recalculation of candidate UI elements for selection. The system interprets the change in directional input as a signal to initiate a pointing-based selection, evaluating spatial alignment between the new raycast direction and potential UI elements across the interface layout. The input magnitude meets the deadzone threshold, and the system continues to interpret the direction for navigation purposes. In this example, the pointing-based selection is active.

A raycast 310 extends from the position of the currently selected UI element, associated with the avatar 302, toward the set of UI elements. The raycast 310 passes through the interface space and is used to evaluate candidate UI elements based on spatial geometry, including one or both of angular deviation and distance relative to the raycast direction.

In the figure, a new UI element 312 has been selected and visually highlighted in response to the pointing-based selection. The selected candidate UI element 312 is visually highlighted, indicating that it is currently active and will be confirmed as the new selection if the input is released. The selection represents a transition from a previous UI element (e.g., the top-left horizontal element from FIG. 3B) to a new UI element (e.g., 312), based on the input direction of the user.

FIG. 3D is a diagram illustrating an example of a virtual experience UI after a directional input has been released, resulting in confirmation of a UI element selection, in accordance with some implementations. The view remains within virtual environment 300, where the avatar 302 continues to occupy a central position. The interface includes multiple UI elements arranged along the right-hand panel, one of which (e.g., 312) has now been selected.

The inset shows the analog stick 304 in its neutral, resting position. The return to the neutral position indicates that the user has released the analog stick, which the system interprets as confirmation of the navigation gesture. The release event triggers a transition from the previously highlighted UI element to a committed selection.

The UI element 312, previously highlighted in FIG. 3C, is now designated as the currently selected UI element. It remains visually outlined to reflect its active state. Navigation input is no longer being processed, and the system may respond to the selection by updating the navigation origin point, invoking associated actions, or preparing for subsequent directional input.

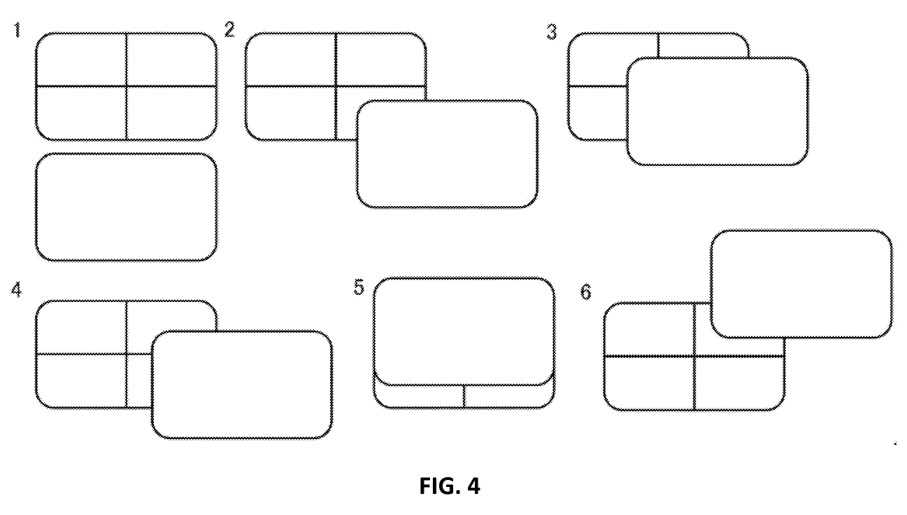

FIG. 4 is a diagram illustrating a set of scenarios for evaluating which UI elements are valid candidates for selection in response to a downward directional input, in accordance with some implementations. Each numbered scenario, labeled 1 through 6, includes a pair of rectangles representing user interface (UI) elements. In each case, the upper rectangle represents the currently selected UI element, and the lower rectangle represents a candidate UI element that may or may not be eligible for selection when the user presses the down direction on an input device such as a directional pad. The currently selected element is shown divided by vertical and horizontal centerlines, which define four quadrants and form the basis for evaluating directional alignment.

In scenario 1, the candidate UI element is positioned directly beneath the currently selected element and is aligned along the same vertical axis. This represents a canonical case for downward navigation, where the input direction closely matches the spatial relationship between the two elements. Because the candidate lies entirely below the selected element and intersects its vertical centerline, it satisfies the directional selection criteria for down.

In scenario 2, the candidate UI element is positioned slightly to the right and below the currently selected element. Although it does not intersect the vertical centerline extending from the current selection, it lies below the horizontal centerline and shares horizontal overlap with the selected element. This horizontal alignment allows the candidate to be selected in response to a downward directional input. The scenario illustrates tolerance for partial alignment along different axes, supporting smoother navigation across interfaces with irregular spacing.

Scenario 3 shows a candidate UI element that overlaps both the vertical and horizontal centerlines of the currently selected element. Because it intersects all four quadrants of the bounding box, the candidate is treated as directionally ambiguous but still qualifies as a valid down selection. The overlap with the vertical axis is sufficient to justify selection in response to a downward command.

In scenario 4, the candidate UI element is located entirely to the right of the currently selected element. Although it intersects the horizontal centerline, it lacks sufficient vertical alignment to be treated as a valid downward target. Instead, the candidate would be more accurately selected via a right directional input. Thus, a down directional input would not select the candidate UI element.

Scenario 5 depicts a candidate UI element that is positioned entirely above the currently selected element. Since the UI element lies in the opposite direction of the intended navigation, it cannot be selected using a downward input. The spatial relationship in the scenario matches the conditions for an up navigation instead.

In scenario 6, the candidate UI element lies in a diagonal region that does not intersect either the vertical or horizontal centerlines of the selected element. The UI element falls outside the scope of the defined directional zones and is not considered a valid candidate for any immediate cardinal direction. The scenario illustrates rejection of elements that are positioned in directions that do not map cleanly to up, down, left, or right inputs.

The scenarios illustrated in FIG. 4 demonstrate how directional selection criteria may account for both alignment with the intended navigation axis and geometric overlap with the bounding region of the currently selected element. This enables flexibility in layout design while preserving predictable and intentional movement behavior across UI elements. The rules shown here apply to a downward input but may be generalized to other cardinal directions using similar alignment heuristics.

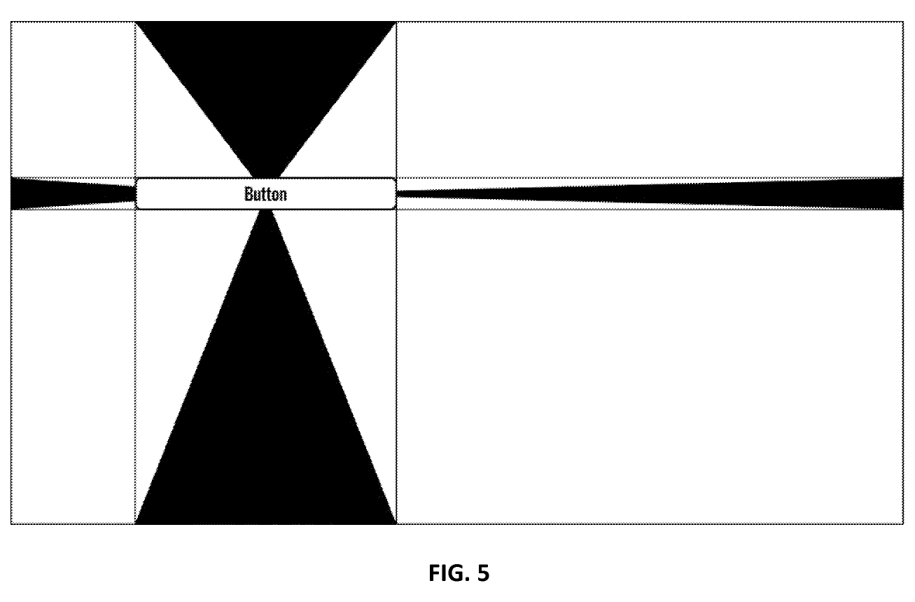

FIG. 5 is a diagram illustrating directional selection techniques that apply when a user is currently selecting a UI element such as a button, in accordance with some implementations. The user is able to push an analog stick in any direction. If the analog stick is within one of the depicted directional cones extending from the center of the selected button, directional selection logic is invoked. The logic restricts potential transitions to UI elements that overlap with vertical or horizontal selection zones, specifically, elements located directly above, below, to the left, or to the right of the currently selected button. The user does not need to aim precisely; instead of evaluating one or both of angle and distance, the logic compares edge-to-edge distance within these directional cones to determine the next selected element.

Once the analog stick points outside these defined horizontal or vertical regions, for example, toward a diagonal such as the top right, the directional selection logic is not applied. At that point, point-and-click selection takes over, incorporating raycasting to determine the target based on one or both of angle and distance. The techniques enable intuitive selection of diagonal elements while still ensuring that UI elements aligned in a strict row or column are reliably reachable via directional input. The hybrid model prevents situations where distant or diagonally positioned buttons are unintentionally prioritized over immediately adjacent elements in common UI layouts.

### Computing device

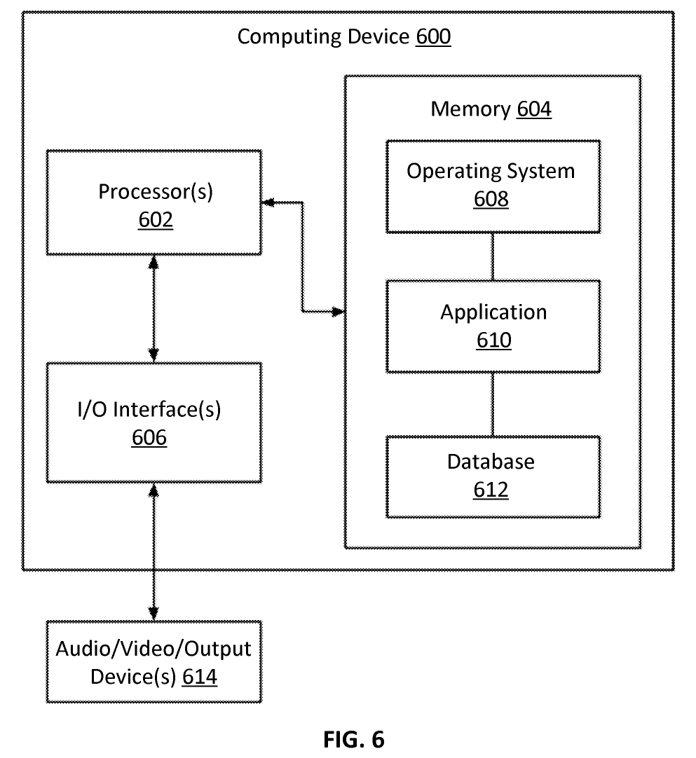

FIG. 6 is a block diagram of an example computing device 600 which may be used to implement one or more techniques described herein. In one example, device 600 may be used to implement a computer device (e.g., 102 and/or 110/130 of FIG. 1), and perform method implementations described herein. Computing device 600 can be any suitable computer system, server, or other electronic or hardware device that is capable of providing selection of UI elements using directional input. For example, the computing device 600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614.

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 604 is provided in device 600 for access by the processor 602, and may be any suitable computer-readable or processor-readable storage medium, e.g., random access memory (RAM), read-only memory (ROM), electrical erasable read-only memory (EEPROM), flash memory, etc., suitable for storing instructions for execution by the processor, and located separate from processor 602 and/or integrated therewith. Memory 604 can store software operating on the server device 600 by the processor 602, including an operating system 608, one or more applications 610, and a database 612 that may store data used by the components of device 600.

Database 612 (which may be embodied by data store 120 of FIG. 1) may store one or more data structures used to support UI element selection in a virtual experience, including directional selection logic, pointer raycasting configurations, and interface geometry descriptors. In some implementations, database 612 may associate these data structures with different interaction modes or interface layouts across virtual reality (VR), augmented reality (AR), gaming, and other immersive environments. The data can include parameters for defining angular selection cones, thresholds for transitioning between directional and point-and-click selection modes, and mappings between analog stick vectors and UI element positions. For instance, the database may store layout metadata that encodes adjacency relationships between selectable UI elements, enabling consistent directional navigation. In some implementations, database 612 may store prior interaction states or confidence scores used to determine whether a new selection input corresponds to an intended transition. Applications 610 may provide instructions that enable processor 602 to execute the described UI selection techniques, such as computing input vectors from analog stick motion, determining overlap with selection cones, and updating the active UI element accordingly.

For example, applications 610 (which may be embodied by applications 112/132 and/or by engines 104/108 of FIG. 1) may include modules for executing selection logic based on user input directionality and spatial layout of UI elements, such as computing analog stick vectors and determining alignment with angular selection zones. In some implementations, applications 610 can incorporate confidence-based mechanisms that determine the reliability of selection input or predict the likelihood of user intent aligning with a specific UI element, enabling disambiguation between multiple candidates. These modules may implement scoring functions based on proximity, directional alignment, and historical input data to refine target selection. Loss functions used in training may include pairwise penalties between predicted and intended UI targets, as well as confidence-weighted losses that account for noise or ambiguity in user input. Database 612, or associated storage, may retain interaction logs, layout metadata, selection vectors, cone definitions, adjacency graphs, and user-specific tuning parameters used to support dynamic and context-aware UI element selection within immersive environments.

Elements of software in memory 604 can alternatively or additionally be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered "storage" or "storage devices."

I/O interface 606 (which can be embodied by the I/O interfaces 114/134 of FIG. 1) can provide functions to enable interfacing the server device 600 with other systems and devices. For example, network communication devices, storage devices (e.g., memory and/or data store 120), and input/output devices can communicate via interface 606. In some implementations, the I/O interface 606 can connect to interface devices including input devices (keyboard, pointing device, touchscreen, microphone, camera, scanner, etc.) and/or output devices (display device, speaker devices, printer, motor, etc.).

The audio/video input/output devices 614 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 6 shows one block for each of processor 602, memory 604, I/O interface 606, and software blocks of operating system 608 and application 610. The blocks may represent one or more processors or processing circuitries, operating systems, memories, I/O interfaces, applications, and/or software engines. In other implementations, device 600 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 600 can be a server device or client device. Example client devices or user devices can be computer devices including some similar components as the device 600 (e.g., processor(s) 602, memory 604, and I/O interface 606). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 614, for example, can be connected to (or included in) the device 600 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively or additionally, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
receiving a directional input from an input device during navigation of a user interface (UI);
determining, based on a direction of the directional input and a position of a currently selected UI element, whether to apply a directional selection or a pointing-based selection;
if the directional selection is applied, selecting a candidate UI element based on alignment and spatial proximity relative to the currently selected UI element and the direction of the directional input;
if the pointing-based selection is applied:
performing a directional raycast originating from the currently selected UI element to obtain a raycast direction; and
selecting the candidate UI element based on one or both of angular deviation and distance relative to the raycast direction;
highlighting the selected candidate UI element; and
detecting a release of the directional input and, in response, updating the currently selected UI element to the selected candidate UI element.

2. The method of claim 1, wherein selecting the candidate UI element based on one or both of angular deviation and distance comprises assigning a weighted score to each candidate UI element based on one or both of angle and distance relative to the raycast direction.

3. The method of claim 1, wherein the directional selection evaluates whether the candidate UI element is aligned with a cardinal axis relative to the currently selected UI element.

4. The method of claim 1, wherein the directional selection defines a bounding region extending outward from the currently selected UI element in the direction of the directional input.

5. The method of claim 1, further comprising:
filtering candidate UI elements based on one or more attributes indicating whether the UI elements are visible and capable of receiving user interaction.

6. The method of claim 1, further comprising:
assigning candidate UI elements to one or more groups based on shared layout structure or metadata, and prioritizing selection among UI elements within a same group.

7. The method of claim 1, wherein the directional input is generated by an analog stick, and wherein detecting the release of the directional input comprises detecting that the analog stick has returned towards a neutral position.

8. The method of claim 1, wherein the directional selection is evaluated prior to the pointing-based selection, and the pointing-based selection is applied in response to a determination that the directional selection does not identify a valid candidate UI element.

9. The method of claim 1, further comprising:
adjusting a region used for directional selection based on a size of the currently selected UI element.

10. The method of claim 1, wherein the raycast is performed in a two-dimensional plane corresponding to spatial positions of the UI elements.

11. The method of claim 1, wherein the direction of the directional input is determined from a displacement vector generated by the input device.

12. A computing device comprising:
one or more processors; and
memory coupled to the one or more processors with instructions stored thereon that, when executed by the one or more processors, cause the one or more processors to perform or control performance of operations comprising:
receiving a directional input from an input device during navigation of a user interface (UI);
determining, based on a direction of the directional input and a position of a currently selected UI element, whether to apply a directional selection or a pointing-based selection;
if the directional selection is applied, selecting a candidate UI element based on alignment and spatial proximity relative to the currently selected UI element and the direction of the directional input;
if the pointing-based selection is applied:
performing a directional raycast originating from the currently selected UI element to obtain a raycast direction; and
selecting the candidate UI element based on one or both of angular deviation and distance relative to the raycast direction;
highlighting the selected candidate UI element; and
detecting a release of the directional input and, in response, updating the currently selected UI element to the selected candidate UI element.

13. The computing device of claim 12, wherein selecting the candidate UI element based on one or both of angular deviation and distance comprises assigning a weighted score to each candidate UI element based on one or both of angle and distance relative to the raycast direction.

14. The computing device of claim 12, wherein the directional selection evaluates whether the candidate UI element is aligned with a cardinal axis relative to the currently selected UI element.

15. The computing device of claim 12, wherein the directional selection defines a bounding region extending outward from the currently selected UI element in the direction of the directional input.

16. The computing device of claim 12, wherein the instructions cause the one or more processors to perform or control performance of a further operation comprising:
filtering candidate UI elements based on one or more attributes indicating whether the UI elements are visible and capable of receiving user interaction.

17. The computing device of claim 12, wherein the instructions cause the one or more processors to perform or control performance of a further operation comprising:
assigning candidate UI elements to one or more groups based on shared layout structure or metadata, and prioritizing selection among UI elements within a same group.

18. The computing device of claim 12, wherein the directional input is generated by an analog stick, and wherein detecting the release of the directional input comprises detecting that the analog stick has returned towards a neutral position.

19. The computing device of claim 12, wherein the directional selection is evaluated prior to the pointing-based selection, and the pointing-based selection is applied in response to a determination that the directional selection does not identify a valid candidate UI element.

20. A non-transitory computer-readable medium with instructions stored thereon that, when executed by a processor, cause the processor to perform or control performance of operations comprising:
receiving a directional input from an input device during navigation of a user interface (UI);
determining, based on a direction of the directional input and a position of a currently selected UI element, whether to apply a directional selection or a pointing-based selection;
if the directional selection is applied, selecting a candidate UI element based on alignment and spatial proximity relative to the currently selected UI element and the direction of the directional input;
if the pointing-based selection is applied:
performing a directional raycast originating from the currently selected UI element to obtain a raycast direction; and
selecting the candidate UI element based on one or both of angular deviation and distance relative to the raycast direction;
highlighting the selected candidate UI element; and
detecting a release of the directional input and, in response, updating the currently selected UI element to the selected candidate UI element.
